(19) United States
(12) Patent Application Publication
(10) Pub. No.: US 2024/0189082 A1
(43) Pub. Date: Jun. 13, 2024

(54) Oral Irrigator Nozzle

(71) Applicant: Shanghai Mange Technology Co., LTD, Shanghai (CN)

(72) Inventor: Pan Fan, Shanghai (CN)

(21) Appl. No.: 18/093,837

(22) Filed: Jan. 6, 2023

(30) Foreign Application Priority Data
Dec. 12, 2022 (CN) 202222396257.6

(51) Int. Cl. A61C 17/032

(52) U.S. Cl. CPC A61C 17/032

(57) ABSTRACT

The present application discloses an oral irrigator nozzle, which comprises a nozzle, a bending part, a connector and a mixed-flow nozzle located at the lower end of the nozzle, wherein the mixed-flow nozzle is provided with a shell, and an inner cavity, wherein the inner cavity is provided with a conical through hole along the water flow direction; the conical head of the conical through hole is connected with an inverted conical through hole; the junction of the conical through hole and the inverted conical through hole forms a throat cavity; the throat cavity is provided with a through hole penetrating the throat cavity; and the end of the through hole is provided with external counterbore. The water jet from the nozzle of the present application can form a cavitation effect, and the water jet contains microbubbles and carries a large amount of air, so that the cleaning power of the water jet can be enhanced after the water jet reaches the teeth, and at the same time, the water jet produces a scattering effect. Compared with single water flow, it is less irritating to gums, less likely to cause gum bleeding and pain, and the cleaning area is larger than that of single water flow. At the same time, the same water pressure can be achieved by using less pump power.

### TECHNICAL FIELD

The present application relates to the field of oral irrigators, in particular to an oral irrigator nozzle.

### BACKGROUND

High-pressure pulse water flow cleaning technology of an oral irrigator is a kind of technology that uses a water pump and a nozzle to form a very fine high-pressure water flow to impact the teeth gap, so as to achieve the purpose of removing food residues and dental plaque from the teeth gap and solve the cleaning problem of the adjacent surfaces of teeth that cannot be brushed by a toothbrush.

There are two existing technical schemes, one is high-pressure pulse water flow, in which the water in the water tank is pumped out by a water pump, and when it flows through the nozzle, the water flow is pressurized by the contraction structure of the nozzle to form high-pressure pulse water flow (the so called pulse means that the water pump will not form continuous water flow when pumping by the piston, but will form periodic water flow with a certain frequency due to the movement of the piston): the other is the form of air spray, in which the air pump pumps out high-speed gas and carries a small amount of water to spray through the nozzle to achieve the purpose of cleaning.

The main characteristics of the high-pressure water flow technology are single water column, fine water flow and large water consumption. In terms of use experience, it is shown that the impact irritation is too strong, which is easy to cause gum injury and gum bleeding. It requires high capacity of water tank, requires a large amount of water to complete a tooth cleaning, and the cleaning effect is general, and the cleaning effect on dental plaque is poor. The jet water flow is mainly sprayed by gas carrying a small amount of water, which is characterized by low water consumption and weak tingling sensation. The disadvantage is that it can only be sprayed once and can't be cleaned continuously. In the use experience, it shows that the cleaning power is not good because of the excessive gas content. Because of its technical characteristics, it can't be cleaned quickly, so it can only be cleaned one by one by single teeth. Therefore, the efficiency is low and the practicability is low. Therefore, we provide a nozzle of tooth washer.

### SUMMARY

In order to overcome the shortcomings of the prior art, the present application provides an oral irrigator nozzle to solve the problems mentioned in the above background technology.

In order to solve the above technical problems, the present application provides the following technical solution: an oral irrigator nozzle including a nozzle and a connector at a lower end of the nozzle, wherein an upper end of the nozzle is connected with a mixed-flow nozzle which is provided with a shell; and an inner cavity, wherein the inner cavity is provided with a conical through hole along the water flow direction: a conical head of the conical through hole is connected with an inverted conical through hole: a throat cavity is formed at the junction of the conical through hole and the inverted conical through hole; the throat cavity is provided with a through hole which runs through the throat cavity, and an end of the through hole is provided with an external counterbore.

As a preferred technical solution of the present application, the surface of the mixed-flow nozzle is sheathed with a silica gel sleeve, and two ends of the silica gel sleeve are penetrated with through holes: the upper side of the silica gel sleeve is higher than the surface of the mixed-flow nozzle, and a cavity is formed between the upper side of the silica gel sleeve and the surface of the mixed-flow nozzle.

As a preferred technical solution of the present application, the two ends of the mixed-flow nozzle are respectively provided with convex parts, and the convex parts extend to the outer ends via through holes.

As a preferred technical solution of the present application, the external counterbore includes a conical hole formed at the outer end of a straight hole and a long inclined hole arranged at one end of the conical hole and inclined to the position of the nozzle.

As a preferred technical solution of the present application, a bending part is arranged between the nozzle and the mixed-flow nozzle.

As a preferred technical solution of the present application, the size of the throat cavity is 0.5 mm-0.65 mm, and the size of the straight hole is 0.3-0.4 mm.

As a preferred technical solution of the present application, the length of the inverted conical through hole is 1.5 mm to 4 mm, and the diameter of a water outlet of the mixed-flow nozzle is 0.8 mm to 1.3 mm.

Compared with the prior art, the present application has the following advantages.

1. The present application can form the cavitation effect of the ejected water flow, and the water flow contains microbubbles and threatens a large amount of air, so that the cleaning power of the water flow can be enhanced after the water flow reaches the teeth.

2. The sprayed water flow has scattering effect, which is less irritating to gums than a single water flow, and is not easy to cause gum bleeding and pain.

3. The cleaning area is larger than that of single stream.

4. The same water flow pressure can be achieved by using less pump power.

### BRIEF DESCRIPTION OF DRAWINGS

FIG. 1 is a schematic structural diagram of the present application:

FIG. 2 is a schematic structural diagram of a mixed-flow nozzle and a silica gel sleeve of the present application:

FIG. 3 is a cross-sectional view of the mixed-flow nozzle of the present application:

FIG. 4 is a front view of the present application:

FIG. 5 is a rear view of the present application:

FIG. 6 is a plan view of the present application.

In the figures: 1. Nozzle: 2. Mixed-flow nozzle: 21. Through hole: 22. Long inclined hole: 23. External counterbore: 24. Conical through hole; 25. Inverted conical through hole: 26. Throat cavity: 3. Silica gel sleeve: 31. Through hole: 4. Connector; 5. Bending part: 6. Mixed-flow nozzle shell: 7. Mixed-flow nozzle inner cavity: 32. Cavity

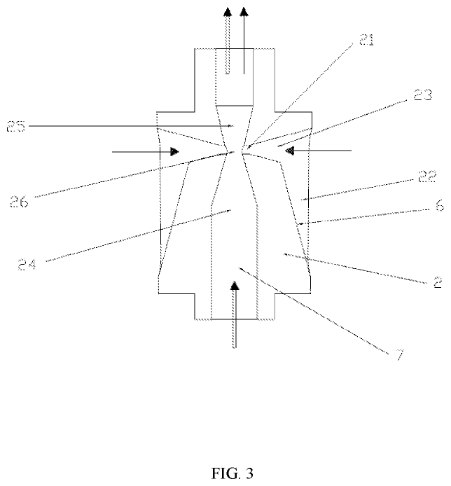

The double-line arrow in FIG. 3 is the direction of water flow, and the single-line arrow is the direction of air flow.

### DESCRIPTION OF EMBODIMENTS

In order to make the technical means, creative features, objectives and effects of the present application easy to understand, the present application will be further explained with reference to specific examples, but the following examples are only the preferred embodiments of the present application, not all of them. Based on the examples in the embodiments, other embodiments obtained by the skilled person without creative labor belong to the scope of protection of the present application. The experimental methods in the following examples are conventional unless otherwise specified, and the materials and reagents used in the following examples can be obtained from commercial sources unless otherwise specified.

### EXAMPLES

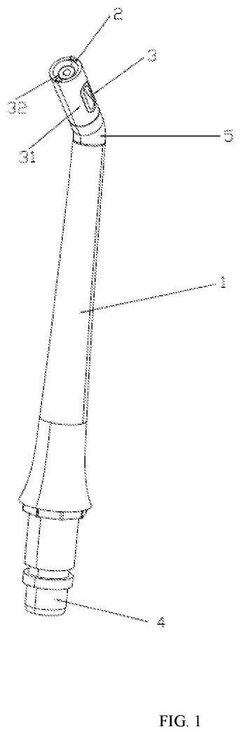

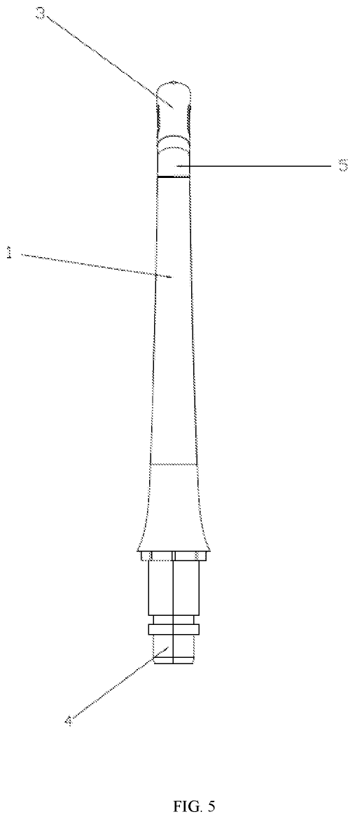

As shown in FIG. 1-FIG. 6, the present application provides a nozzle for oral irrigator, which includes a nozzle 1, a bending part 5 and a connector 4 at the lower end of the nozzle 1. The surface of the connector 4 is provided with a clamping groove, and at the same time mates with a buckle at the joint of the host machine of the oral irrigator for connecting with a water tank. The lower end inside the nozzle 1 is provided with a water pump, the input end of which is connected with a conduit, and the upper end of the nozzle 1 is connected with a mixed-flow nozzle 2, which is embedded in the mold of the nozzle 1 during injection molding. The nozzle 1 wraps the mixed-flow nozzle 2 during injection molding, and the surface of the mixed-flow nozzle 2 is sheathed with a silica gel sleeve 3 o form a soft gel shell which can play a role of protecting teeth. The mixed-flow nozzle is provided with a shell 1 and an inner cavity 2, wherein the inner cavity 2 is provided with a conical through hole 24 along the water flow direction: the conical head of the conical through hole 24 is connected with an inverted conical through hole 25. A throat cavity 5 is formed at the junction of the conical through hole 24 and the inverted conical through hole 25. The throat cavity 5 is provided with a through hole 21 penetrating the throat cavity, and the end of the through hole 21 is provided with an external counterbore 23. The throat cavity is 0.5 mm-0.65 mm in size, and through holes 21 at both ends symmetrically penetrate through the two ends of the throat cavity, and the through holes 21 are 0.3-0.4 mm in size.

In this embodiment, the nozzle 1 is clamped with the host machine of the oral irrigator by the connector 4, and then the water flow is guided into the mixed-flow nozzle 2 by the action of the water pump. At the moment when it passes through the smallest diameter of the throat cavity of the mixed-flow nozzle 2, due to the side wall pressure, the water flows faster and the side wall pressure of the nozzle 1 becomes smaller. Therefore, setting the through hole 21 at this position can form the effect that the air flow is sucked into the mixed-flow nozzle 2, and it will not cause water overflow; thus avoiding water leakage. After the gas is sucked in, it mixes with the water flow to form a mixed fluid which is ejected from the top of the mixed-flow nozzle 2, and the water flow can form a vacuolus effect. The water flow contains microbubbles and threatens a large amount of air, which can enhance the cleaning power of the water flow after it reaches the teeth. At the same time, the water flow produces a scattering effect, which is less irritating to the gums than a single water flow, less likely to cause gum bleeding and pain, and the cleaning area is larger than that of a single water flow. At the same time, the same water pressure can be achieved by using a smaller pump power.

The sizes of the through holes 21 at both ends are set to 0.3-0.4 mm, and the throat size is set to 0.5 mm-0.65 mm. The throat diameter can adjust the water-saving amount and the relationship between the pressure range and the intake air volume, so as to achieve different water-saving and cleaning needs. The conical hole 23 at the outer end of the through hole 21 increases the area of gas entering the mixed-flow nozzle 2, thus preventing the situation that the too small through hole 21 is easily blocked and cannot be inhaled.

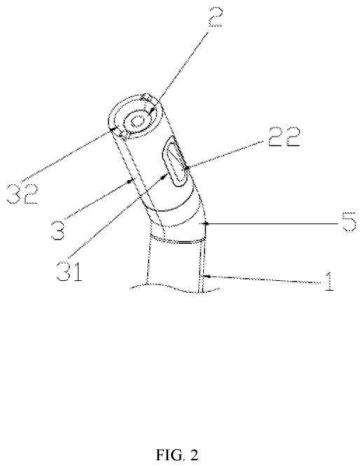

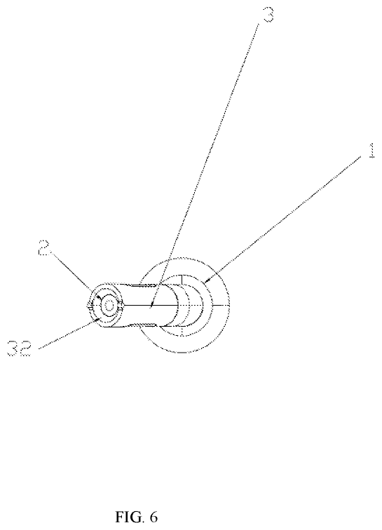

As shown in FIGS. 2 and 6, this embodiment discloses that the upper side of the silica gel sleeve 3 is higher than the surface of the mixed-flow nozzle 2, and a cavity 32 is formed between the upper side of the silica gel sleeve 3 and the surface of the mixed-flow nozzle 2.

In this embodiment, when in use, the nozzle head 1 will enter the mouth and contact the teeth or gums. Through the cavity formed between the upper side of the mixed-flow spray head 2 and the upper end of the silica gel sleeve 3, the nozzle head 1 can keep a certain distance from the teeth and keep a certain amount of air. The water-vapor mixed fluid flows through this cavity to further spray the water vapor evenly on the teeth surface, so as to clean a larger area and reduce the tingling sensation.

As shown in FIG. 3, this embodiment discloses that the length of the inverted conical through hole 25 formed at the lower end of the throat cavity is between 1.5 mm and 4 mm, and the diameter of the water outlet of the mixed-flow nozzle 2 is between 0.8 mm-1.3 mm;

In this embodiment, the length of the inverted conical through hole 25 is set between 1.5 mm-4 mm and 4 mm, and the formed water flow has the best scattering effect. If it exceeds this range, the scattering effect is not good. Meanwhile, the outlet diameter of the mixed-flow nozzle 2 is between 0.8 mm and 1.3 mm, and the water flow formed by 1.3 mm has the best scattering effect.

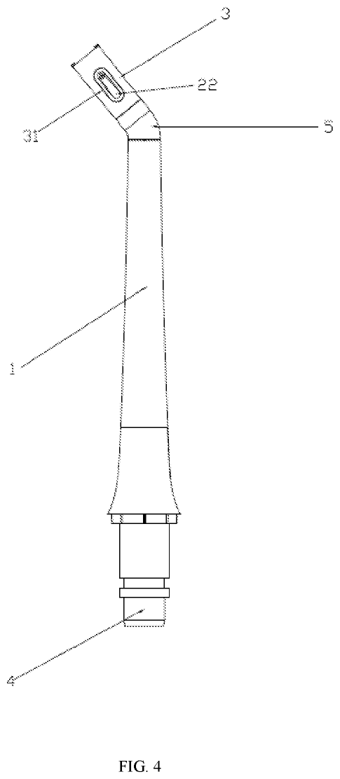

As shown in FIG. 2, FIG. 3 and FIG. 4, this embodiment discloses that one end of the external counterbore 23 can be provided with a long inclined hole 22 inclined to the position of the nozzle 1: the area of gas entering the mixed-flow nozzle 2 is further increased to prevent blockage.

Although the embodiments of the present application have been shown and described, it will be understood by those skilled in the art that many changes, modifications, substitutions and variations can be made to these embodiments without departing from the principle and spirit of the present application, and the scope of the present application is defined by the appended claims and their equivalents.

What is claimed is:

1. An oral irrigator nozzle, comprising a nozzle and a connector at a lower end of the nozzle, wherein an upper end of the nozzle is connected with a mixed-flow nozzle which is provided with a shell; and an inner cavity, wherein the inner cavity is provided with a conical through hole along the water flow direction: a conical head of the conical through hole is connected with an inverted conical through hole: a throat cavity is formed at the junction of the conical through hole and the inverted conical through hole; the throat cavity is provided with a through hole which runs through the throat cavity, and an end of the through hole is provided with an external counterbore.

2. The oral irrigator nozzle according to claim 1, wherein the surface of the mixed-flow nozzle is sheathed with a silica gel sleeve, and two ends of the silica gel sleeve are penetrated with through holes: the upper side of the silica gel sleeve is higher than the surface of the mixed-flow nozzle, and a cavity is formed between the upper side of the silica gel sleeve and the surface of the mixed-flow nozzle.

3. The oral irrigator nozzle according to claim 2, wherein the two ends of the mixed-flow nozzle are respectively provided with convex parts, and the convex parts extend to the outer ends via through holes.

4. The oral irrigator nozzle according to claim 3, wherein the external counterbore comprises a conical hole formed at the outer end of a straight hole and a long inclined hole arranged at one end of the conical hole and inclined to the position of the nozzle.

5. The oral irrigator nozzle according to claim 4, wherein a bending part is arranged between the nozzle and the mixed-flow nozzle.

6. The oral irrigator nozzle according to claim 1, wherein the size of the throat cavity is 0.5 mm-0.65 mm, and the size of the straight hole is 0.3-0.4 mm.

7. The oral irrigator nozzle according to claim 6, wherein the length of the inverted conical through hole is 1.5 mm to 4 mm, and the diameter of a water outlet of the mixed-flow nozzle is 0.8 mm to 1.3 mm.
